(19) United States
(12) Patent Application Publication
(10) Pub. No.: US 2021/0331006 A1
(43) Pub. Date: Oct. 28, 2021

(54) Head-mounted Air Purifier

(71) Applicant: Mukundakumar Rajukumar, Fremont, CA (US)

(72) Inventor: Mukundakumar Rajukumar, Fremont, CA (US)

(21) Appl. No.: 17/235,943

(22) Filed: Apr. 21, 2021

Related U.S. Application Data
(60) Provisional application No. 63/014,007, filed on Apr. 22, 2020.

(51) Int. Cl. A62B 23/02; B03C 3/02; B03C 3/32; B03C 3/36; A42B 3/28; A62B 9/00; A62B 18/04; A62B 9/04; A62B 18/08

(52) U.S. Cl. CPC A62B 23/02; B03C 3/025; B03C 3/32; B03C 3/368; A42B 3/28; B03C 2201/24; A62B 18/04; A62B 9/04; A62B 9/006; A62B 18/084; A62B 9/00

(57) ABSTRACT

A portable air purifier device includes a fan, air purification system, air quality sensor module, air crossflow limiter and a head mount. The air purifier is mounted in the forehead/head area without blocking the user's nose, mouth or face area, making it easy to breathe. The air purification system consists of one or more Electrostatic Precipitators connected together, in series to achieve higher level of air purification efficiency or in parallel to achieve higher output air flow rate. The crossflow limiter blocks dirty air from the outside from displacing the cleansed air supplied by the device. The air quality sensor module automatically throttles the air purification up/down based on the air pollution level surrounding the user. The head mount is used to easily mount the air purifier device either directly onto the user's head or on top of any head-wear such as a helmet or a hat.

### FIELD

The present disclosure relates to air purifiers and, more particularly, to portable air purifier devices.

### BACKGROUND

The personal air purifier device is generally in the form of masks that cover the users' nose and mouth area. Users often experience discomfort within a few minutes of wearing the device due to low pressure and moisture build-up. The mask of the device may also become clogged with dust quickly and needs to be replaced frequently.

Some users wear face shields that do not clean the air but rather only block or bar large infectious aerosol droplets suspended in the air, for example, respiratory droplets traveled into the air from cough, sneeze, talk, shout, or sing, etc. Smaller aerosol particles, however, can remain airborne longer and flow around the face shields more easily to be inhaled. In addition, the airborne pollutants may not be filtered out by the face shields either. Thus, they are not a substitute for respiratory protection.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The present disclosure generally provides a portable air purifier device that mounts on a user's head without covering the user's face area. This device may include an air-flow control fan, an air purification system such as electro-static precipitator (ESP), an air crossflow limiter, an air quality sensor module, and a head-mounting mechanism. In a feature, depending on the amount of pollutants and pathogens present in the environment, some example devices may be fitted with a different number of ESP units connected together to achieve desired air purification efficiency. In further features, the air-flow control fan of the portable air purifier device regulates the rate at which air flows into the air purification system to achieve a desired level of air purification and user comfort. In further features, the air cross-flow limiter of the portable air purifier device blocks dirty air and microbes from entering the user's nose or mouth from the sides and from the front. In one example, the air cross flow limiter takes the form of a see-through visor covering the user's face on either side and extends downwards to cover the user's nose and mouth. In further features, the air quality sensor module of the portable air purifier device measures one or more air quality parameters such as particulate matter level, humidity level, and ozone level in the location of the user and provides feedback to the portable air purifier device to adjust air purification function and intensity. In further features, the head-mount of the portable air purifier device holds the entire device firmly on the user's head.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a perspective view of an example wearable air purifying device 100.

FIG. 2 shows another perspective view of the example air purifying device 100 with its top cover removed.

FIG. 3 shows still another perspective view of the example air purifying device 100.

FIG. 4 shows the example air purification device 100 with an example cross-flow limiter in the form of a see-through visor 110 mounted onto a user using a mounting mechanism 108.

FIG. 5 shows an example air purifying device 200 with a single ESP unit.

FIG. 6 shows an example L-shaped air purifying device 300 with two ESP units connected in series.

FIG. 7 shows an example C-shaped air purifying device 400 with three ESP units connected in series.

FIG. 8 shows an example V-shaped air purifying device 500 with two ESP units connected in parallel.

In the drawings, reference numbers may be reused to identify similar and/or identical elements.

### DETAILED DESCRIPTION

A personal air purifier built in miniature form to mount on the user's forehead or head area makes it convenient for the user to breathe normally without any difficulty, by not blocking the user's nose or mouth area.

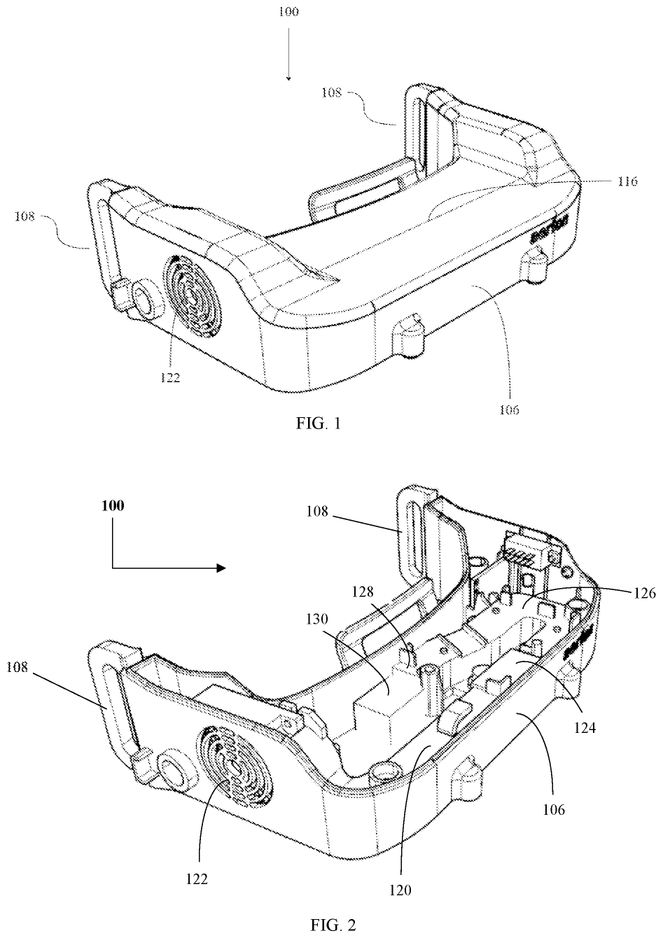

FIG. 1 illustrates an example air purifier device 100 containing a base enclosure 106 of the device 100 including a fan 122 and an air purification system (not shown) and is protected by a top cover 116. The back of the device 100 may also be attached with an example mounting mechanism 108 to strap the device 100 onto the user's head or the user's headwear.

FIG. 2 shows the example air purifier device 100 with the top cover (not shown) removed. The base enclosure 106 of the device 100 contains the fan 122 on the external side, an example air purification system called Electrostatic Precipitator (ESP) 120 attached to the outlet of the fan 122 and an air quality sensor module 130 at the outlet 128 of the ESP 120.

ESP 120 includes an ion sprayer 124, and a metal dust collection chamber 126. The fan 122 is equipped on an external side of the base enclosure 106 and takes in dirty air and feeds the dirty air to the metal dust collection chamber 126. The ion sprayer 124 placed at the front of the dust collection chamber 126 creates a high intensity electric field inside the chamber 126 that destroys pathogens such as bacteria and viruses. The ions emitted from the electric field bond with the dead pathogens and harmful pollutants such as particulate matter in the air and attach to inside metal walls of the dust collection chamber 126. The cleaned air comes out through the air outlet 128 and sprays towards the user's nose area. The entire ESP unit is placed inside the base enclosure 106 that may be, for example, an air-tight enclosure to prevent any leaks and mixing of dirty air from outside with the cleaned air.

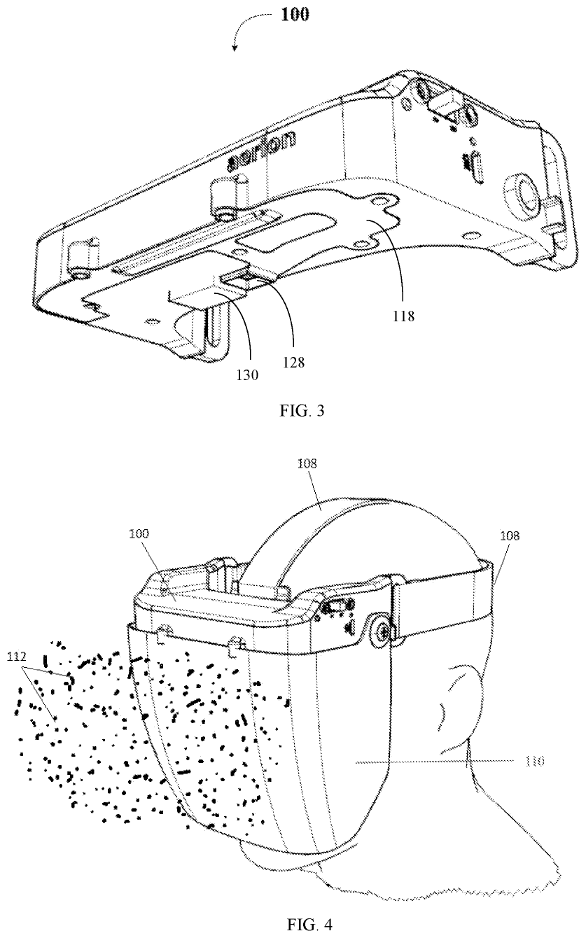

As shown in FIG. 3, the example air purifying device 100 may further include a lid 118 that the user can remove to access the dust collection chamber for washing and/or replacing.

A built-in air quality sensor module 130 at the air outlet 128 measures the various characteristics of the air at the air outlet 128 including dust level, humidity, and/or temperature. This example air quality sensor module 130 may contain one or more of three different sensors: a Particulate Matter (PM) sensor, a humidity sensor, and/or an ozone sensor. The PM sensor measures the particulate matter concentration surrounding the user and can turn the air purifier ON when the PM level exceeds the WHO safe limit, [mow] and turn the air purifier OFF when the PM level is lower than the WHO safe limit. When the user is moving and the PM sensor notices increasing levels of pollution, the device 100 can throttle up the air purification intensity. When the PM sensor notices that the air quality is within WHO safe limit, the air purification intensity is throttled down. The second sensor in the example air quality sensor module 130 can be the humidity sensor. When the sensor detects water spray or rain on the air purifying device 100, the device 100 can shut itself OFF to prevent any damage to the electrical circuitry of the device 100 and more importantly, for the user's safety. The third sensor in the example air quality sensor module may be the ozone sensor that can shut off the device in case the air purifying device malfunctions and generates unsafe levels of ozone.

The air purifying device 100 can be well-suited for outdoor use with a rechargeable battery to make the device wire-free and portable. The air purification process is power-intensive; hence air purification is turned ON only when needed. Also, based on real-time feedback from the air quality sensor, the air purification intensity is adjusted to achieve a desired air quality and not over-exerted, in order to conserve power/battery drain.

FIG. 4 shows an example air cross-flow limiter in the form of a see-through visor 110 attached to the air purifying device 100. The visor 110 blocks any dirty air 112 coming from the sides or from the front and entering the user's nose or mouth area. Packets of dirty air 112 can rush in from the sides or from the front and easily displace the cleansed air, if not stopped.

As shown in FIG. 4, the example mounting mechanism 108 can be a head mount mechanism (e.g., a strap) attached to the device 100. The air purifying device 100 can be mounted onto the user's head directly using the strap 108. The air purifying device 100 can also be attached on top of other headgears, such as a hard hat or a helmet, using the same strap 108. Thus, the air purifying device 100 is flexible enough to be worn when performing various outdoor activities such as walking, jogging, commuting to work on a two-wheeler or playing sports.

Multiple Electrostatic Precipitator (ESP) units can be connected in series to improve their performance efficiency. The air coming out of one ESP unit is fed as an input to the next ESP unit to do another round of dust and microbe removal. In a highly polluted environment, multiple ESP units connected in series can significantly increase the air purification efficiency.

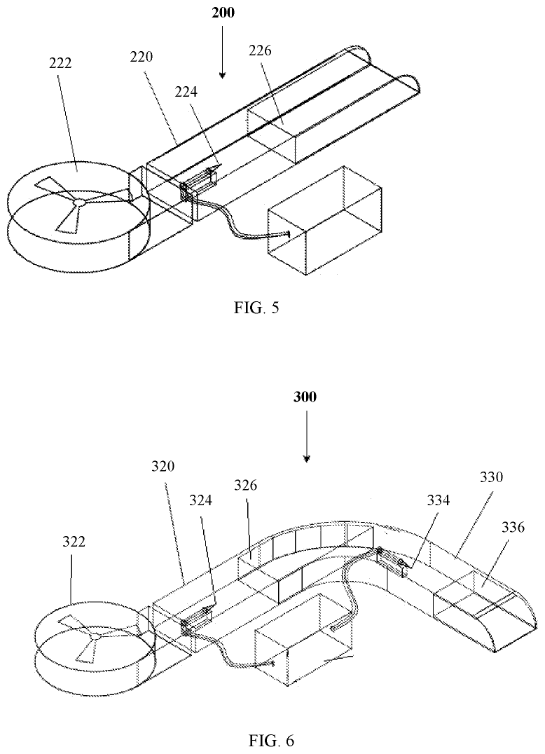

FIG. 5 shows an example air purifying device 200 with a fan 222 and one ESP unit 220 connected to the outlet of the fan 222. The ESP unit 220 includes an ion sprayer 224 and a dust collection chamber 226. The fan 222 draws in dirty air from the atmosphere into the air purifying device 200. The dirt and dust in the air bonds with ions sprayed by the ion sprayer 224 and attaches to the dust collection chamber 226 (e.g., a metal dust collection chamber, etc.), and out comes clean air.

ESP units can be inter-connected and arranged in various shapes such as V, L, C, U. FIG. 6 shows an example device 300 with a fan 322 and two ESP units 320 and 330 arranged in L-shape and connected in series. The fan 322 draws in dirty air and feeds the first ESP unit 320 attached to the outlet of the fan 322. The ESP unit 320 includes an ion sprayer 324 and a first dust collection chamber 326. The dirt bonds with ions sprayed by the ion sprayer 324 and gets trapped on the walls of the first dust collection chamber 326 (e.g., a metal dust collection chamber, etc.). The cleansed air passes through the second ESP unit having an ion sprayer 334 and the second collection chamber 336 (e.g., another metal dust collection chamber, etc.) for another round of cleaning. Any leftover dust in the air gets trapped to this second dust collection chamber 336 and out comes clean air.

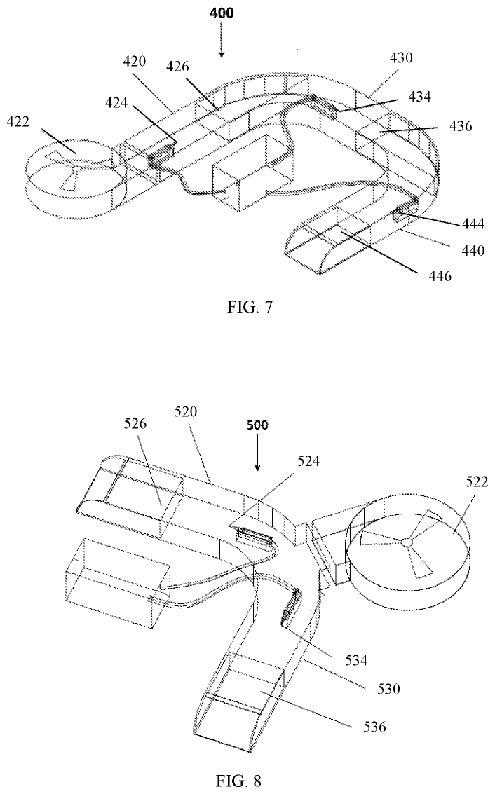

FIG. 7 shows an example air purification device 400 with a fan 422 and three ESP units 420, 430, 440 arranged in, for example, a C-shape, and connected in series. The device 400 may include a fan 422 and three ESP units connected in series to use in places where the incoming air has a lot of dust and a single ESP unit may not achieve the desired air purification efficiency. The fan 422 draws in dirty air and feeds into the first ESP unit 420 connected to the outlet of the fan 422. The ESP unit 420 includes an ion sprayer 424 and a dust collection chamber 426. The dirt bonds with ions sprayed by the ion sprayer 424 and gets trapped in the first dust collection chamber 426. The air coming out of chamber 426 passes into the second ESP unit 430 having an ion sprayer 434 and a second dust collection chamber 436 for another round of cleaning. The walls of the second dust collection chamber 436 trap more of the dust particles in the air. The output from the second ESP unit 430 enters the third ESP unit 440 having an ion sprayer 444 and a third dust collection chamber 446 for one more round of cleaning, and out comes clean air.

Further, an air purification system may include multiple (e.g., more than three) ESP units that are connected in parallel to increase the output air flow rate at any given air purification efficiency. This is suitable for environments where higher air flow rate is desired such as when the device is used to clean a larger space such as a room versus a person's face area.

FIG. 8 shows another example air purification device 500 with a fan 522 and two ESP units 528, 538 connected in parallel in a shape of V. Parallel connected ESP units can also be easily arranged in various other shapes such as L, C, U to best fit the air purifier device 500. The example device 500 may include a fan 522 and two ESP units 528, 538 connected in parallel. The first ESP unit 520 may be disposed on one side and include an ion sprayer 524 and a first dust collection chamber 526. The second ESP unit 530 may be disposed on the other side and include an ion sprayer 534 and a second dust collection chamber 536. The fan 522 draws in dirty air and feeds to the two ESP units, thus doubling the amount of air being cleaned compared to using only one ESP unit. The dirt entering one side bonds with ions sprayed by the ion sprayer 524 and attaches to the corresponding first dust collection chamber 526. The dirt entering the other side bond with the ions sprayed by the ion sprayer 534 and the second collection chamber 536. Clean air comes out of both the top and bottom outlets to supply twice the amount of clean air compared to that of a single ESP unit.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments described above as having certain features, any one or more of those features described with respect to any embodiment of the disclosure can be implemented in and/or combined with the features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected”, “engaged”, “coupled”, “adjacent”, “next to”, “on top of”, “above”, “below”, and “disposed”. Unless explicitly described as being “direct”, when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A or B or C), using a non-exclusive logical OR, and should not be construed to mean “at least one of A, at least one of B, and at least one of C”.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receive acknowledgements of, the information to element A. The term subset does not necessarily require a proper subset. In other words, a first subset of a first set may be coextensive with (equal to) the first set. In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

What is claimed is:

1. A portable air purifier device comprising:
a base enclosure;
an air-flow control fan equipped to an external side of the base disclosure,
an air purification system disposed within the base enclosure,
and
a head mounting mechanism attached to the portable air purifier device,
wherein the portable air purifier device is releasably mounted either directly or indirectly onto a headwear using the head mounting mechanism.

2. The portable air purifier device of claim 1, wherein the air purifier device is mounted onto the headwear of a user to supply clean air for the user to inhale without blocking the user's nose, mouth or face area.

3. The portable air purifier device of claim 2 further comprising an air cross-flow limiter attached to the portable air purifier device, wherein the air cross-flow limiter blocks surrounding dirty air from entering into the user's nose area.

4. The portable air purifier device of claim 2 further comprising an air quality sensor module adjacent to an outlet of the portable air purifier device, wherein the air quality sensor module measures various parameters of atmosphere surrounding the user to determine when to turn ON/OFF the air purifier device and throttle up/down the air purification intensity to keep inhaled air safe and clean.

5. The portable air purification device of claim 4, wherein the measured various parameters include at least one of a particulate matter, a particulate dust, a humidity level, a nitrogen dioxide level, a sulphur dioxide and an ozone gas level.

6. The portable air purifier device of claim 1, wherein the air purification system is equipped with one or more electrostatic precipitators (ESPs) that are arranged in series to achieve various levels of air purification efficiency as required.

7. The portable air purifier device of claim 1, wherein the air purification system is equipped with one or more electrostatic precipitators (ESPs) that are arranged in parallel to achieve various levels of output air flow rate as required.

8. The portable air purifier device of claim 1, wherein the head mounting mechanism is a strap that is adapted to attach to the headwear.

9. The air purifier device of claim 8, wherein the headwear is a hat, a helmet, or a visor.

10. A method of providing clean air using a portable air purifier device, the method comprising:
disposing an air purification system in the portable air purifier device within a base enclosure of the portable air purifier device;
equipping an air-flow control fan on an external side of the base enclosure; and
attaching a head mounting mechanism to the portable air purifier device,
wherein portable air purifier device is configured to be releasably mounted directly or indirectly onto a headwear using the head mounting mechanism.

11. The method of claim 10 further comprising:
mounting the portable air purifier device onto the headwear of a user to provide clean air for the user to inhale without blocking the user's nose, mouth or face area.

12. The method of claim 11 further comprising:
attaching an air crossflow limiter to the portable air purifier device to block surrounding dirty air from entering into the user's nose area.

13. The method of claim 11 further comprising:
disposing an air quality sensor module adjacent to an outlet of the portable air purifier device to measure various parameters of atmosphere surrounding the user to determine when to turn ON/OFF the air purifier device and throttle up/down an air purification intensity to keep inhaled air safe and clean.

14. The method of claim 13 further comprising:
measuring various parameters include at least one of a particulate matter, a particulate dust, a humidity level, a nitrogen dioxide level, a sulphur dioxide level and an ozone gas level, using the air quality sensor module.

15. The method of claim 10 further comprising:
equipping the air purification system with one or more electrostatic precipitators that are arranged in series to achieve various levels of air purification efficiency as required.

16. The method of claim 10 further comprising:
equipping the air purification system with one or more electrostatic precipitators that are arranged in parallel to achieve various levels of output air flow rate as required.

17. The method of claim 10, wherein the head mounting mechanism is a strap that is adapted to attach to the headwear.

18. The method of claim 17, wherein the headwear is a hat, a helmet, or a visor.
